(19) United States
(12) Patent Application Publication
(10) Pub. No.: US 2021/0168129 A1
(43) Pub. Date: Jun. 3, 2021

(54) SYSTEM AND METHOD FOR PERSISTENT AUTHENTICATION OF A USER FOR ISSUING VIRTUAL TOKENS

(71) Applicant: Capital One Services, LLC, McLean, VA (US)

(72) Inventors: Joshua EDWARDS, Philadelphia, PA (US); Abdelkader BENKREIRA, Washington, DC (US); Adam VUKICH, Alexandria, VA (US)

(21) Appl. No.: 16/700,946

(22) Filed: Dec. 2, 2019

(51) Int. Cl. H04L 29/06; G06F 21/62

(52) U.S. Cl. CPC H04L 63/083; H04L 63/0876; H04L 2463/082; G06F 21/6254; H04L 63/0861

(57) ABSTRACT

Systems and methods for persistent authentication of a user are described, before generating virtual tokenized information, by evaluating the user's primary authentication information and secondary authentication information submitted in connection with a request for a virtual token.

### FIELD OF THE INVENTION

The present invention relates to systems and methods for persistent authentication of a user before generating and issuing virtual tokens or other virtual tokenized information.

### BACKGROUND

Protecting personal information can be difficult for users to do when participating in activities online. Personal information may be necessary for the user to participate in various online activities, and the user may not be able to monitor or control what happens to the information, or whether the information is sufficiently safeguarded. Internet communications are often insufficiently secure, such that third parties may intercept or otherwise intrude upon Internet communications without authority to do so. Moreover, even if the information communicated over the Internet is communicated in a secure manner, the information may be stored in an insufficiently secure manner, susceptible to unauthorized access by third parties. Further still, the recipients of the Internet communication may share the personal information without the authorization or approval of the user. To avoid submitting personal information, in certain circumstances it is possible to submit tokenized versions of the personal information, for use in online activities. The tokenized versions of the personal information can replace the actual personal information with a randomly-generated identifier that is representative of the personal information. The tokenized information can then be used without concern that the personal information will be exposed.

Similarly, for interactions occurring online, where the user or other participants are not physically present, and are participating using a personal electronic device, sufficiently authenticating the user can be difficult. In particular, where a user's personal information is intentionally being replaced with a tokenized version of that personal information, it is important to authenticate the user, to ensure that the tokenized version of the personal information is attributed to the proper user. Accordingly, access to a token generated to replace personal information may first require the user to undergo significant authentication procedures. In certain circumstances, the repeated access to tokenized information can cause significant authentication burdens on the user and the authentication system. It is also possible that the added burden of authentication to access the tokenization process will prevent users from availing themselves of the tokenization process to protect their information.

Thus, there is a need for improved authentication processes that are simple and easy to execute, while also effectively ensuring that the proper user is permitted to access generated virtual tokens.

### SUMMARY

The following systems and methods provide persistent user authentication for generating and issuing virtual tokens or other virtual information. To allow a user to avoid submitting their personal information, the user can be granted a tokenized version of that personal information. But before such tokens are generated, the user must be reliably authenticated. In many cases, repeated tokenized information is required, so the authentication procedure should be easy to execute. Therefore, systems and methods described herein describe a primary authentication procedure for authenticating a user, and a secondary authentication procedure for confirming or maintaining the primary authentication.

Virtual information can protect a user's true information, because the true information need not be used online at all. When a user is required to submit sensitive personal information, such as social security numbers, medical records, vehicle information, tax information, or financial information, that information can be replaced with a randomly-generated virtual token or “virtual” information, to be submitted in place of the actual personal information. The virtual information will have information different from the user's true personal information, such as a different number or string of numbers. The user therefore need not worry that a third party may have access to the virtual information, because the virtual information has no use outside of the specific use for which it was generated.

A virtual token has the flexibility to be limited or designated to apply or not apply in certain circumstances. For example, a virtual token may be limited to a certain interaction, a certain counter-party, or a certain period of time.

In example embodiments, the authentication process begins with a user registration, in which the user provides the basic information necessary to identify the user, to associate the user with any relevant accounts or profiles, and to set up authentication information. The user's authentication information may include, for example, usernames, passwords, facial images, gestures, hardware identification information, internet protocol addresses, or the like. All of this information may then be stored in memory, to be recalled and used in evaluating the authenticity of a user. A primary authentication procedure is first carried out, which requires the user to submit the necessary authentication information and resolve the necessary security inquiry. Then, following the primary authentication of the user, a persistent, passive, secondary authentication procedure may be used to permit the issuance and application of virtual tokens, securing the user's personal information over time without the burden or repeated submission of primary authentication information.

In an exemplary embodiment, the method for persistent authentication of a registered user of a user device may comprise following the initiation, on the user device, of a primary network browsing session for sending and receiving information over a network, receiving, by the user device, primary authentication information associated with the registered user of the user device, transmitting, by the user device, to a server, a primary authentication request including the primary authentication information and a hardware identifier associated with the user device, and receiving, by the user device, from the server, a primary verification message. During the primary network browsing session or during a subsequent network browsing session, the method may further comprise detecting, on the user device, an input field requesting user information. The method may further comprise determining, by the user device, that the primary verification message has been received. If the primary verification message has been received, the method may further comprise initiating, by the user device, a camera associated with the user device to capture a secondary authentication image of the current user operating the device. The method may further comprise transmitting, by the user device, to a server, a secondary authentication request including the secondary authentication image and the hardware identifier, receiving, by the user device, from the server, a secondary verification message indicating that the user is authenticated based on the secondary authentication image and the hardware identifier or a failure message indicating that the user is not authenticated based on the secondary authentication image and the hardware identifier, and, if the secondary verification message is received, populating the input field with a tokenized version of the user information requested by the input field.

In an exemplary embodiment, the step of transmitting the primary authentication request may further include determining a primary authentication internet protocol address of the user device indicating the internet protocol address of the user device at the time of the primary authentication request, and including the determined primary authentication internet protocol address of the user device in the primary authentication request. The step of transmitting the secondary authentication request may further include determining a secondary authentication internet protocol address of the user device indicating the internet protocol address of the user device at the time of the secondary authentication request, and including the determined secondary authentication internet protocol address of the user device in the secondary authentication request. The secondary verification message or failure message may further be based on a comparison of the primary authentication internet protocol address of the user device and the secondary authentication internet protocol address of the user device.

In an exemplary embodiment, the method may further comprise, at the initiation of a subsequent network browsing session, initiating, by the user device, the camera associated with the user device to capture a browsing session image of the user, and transmitting, by the user device, to the server, the browsing session image of the user, wherein the secondary verification message or failure message is further based on a comparison of the browsing session image and the secondary authentication image.

In an exemplary embodiment, the initiation of the camera associated with the user device may include displaying, on a display of the user device, a prompt for the user to enter a command for the camera to capture the secondary authentication image.

In an exemplary embodiment, the method may further comprise, if the failure message is received, declining to populate the input field. The method may further comprise, if the failure message is received, prompting the user to submit the primary authentication information, transmitting, by the user device, to the server, an additional primary authentication request including the resubmitted primary authentication information, receiving, by the user device, from the server, an additional primary verification message including a tokenized version of the user information requested by the input field, and, if the additional primary verification message is received, populating the input field with the tokenized user information.

In an exemplary embodiment, the method may further comprise, if the failure message is received, disabling at least one of: the method step of detecting, on the user device, the input field requesting user information, and the method step of transmitting the secondary authentication request. The disabling step may be disabled for a predetermined period of time.

In an exemplary embodiment, the secondary verification message may include the tokenized version of the user information. The secondary verification message may include a call to a local memory of the user device storing the tokenized version of the user information.

In an exemplary embodiment, the method may further comprise detecting the party requesting the user information via the input field, comparing the party to a list of trusted parties, and, if the party is included in the list of trusted parties, populating the input field with locally stored user information.

In an exemplary embodiment, the primary authentication information associated with the registered user of the user device may include at least one of: a user's name, a user identifier, a password, or an answer to a security question.

In an exemplary embodiment, a method for persistent authentication of a registered user of a user device may comprise storing, in a user authentication database on a server, registered primary authentication information associated with the registered user, a registered hardware identifier associated with the user device, and at least one registered image of the registered user, receiving, by the server, from the user device, a primary authentication request including primary authentication information and a hardware identifier, comparing, by the server, the received primary authentication information and hardware identifier to registered primary authentication information and the registered hardware identifier stored in the user authentication database, if the received primary authentication information and hardware identifier match the registered primary authentication information and the registered hardware identifier stored in the user authentication database, transmitting, by the server, to the user device, a primary verification message, and, in the user authentication database, storing a primary verification flag with the hardware identifier, receiving a browsing session initiation message from the user device, including a request for a tokenized version of user information, receiving, by the server, from the user device, a secondary authentication request including a secondary authentication image of the current user operating the device and the hardware identifier, determining whether the user authentication database entry for the hardware identifier includes the primary verification flag, if the user authentication database entry for the hardware identifier includes the primary verification flag, comparing the secondary authentication image of the current user with the at least one registered image of the registered user, and determining the probability that the current user is the registered user, and, if the probability that the current user is the registered user is above an authentication threshold, tokenizing the requested user information, and transmitting, by the server, to the user device, a secondary verification message indicating that the user is authenticated based on the secondary authentication image and the hardware identifier.

In an exemplary embodiment, the method may further comprise, if the probability that the current user is the registered user is below the authentication threshold, and above an authentication uncertainty threshold, transmitting, by the server, to the user device, a failure message indicating that the user is not authenticated based on the secondary authentication image and the hardware identifier, wherein the failure message includes a request for an additional primary authentication request, receiving, by the server, from the user device, the additional primary authentication request including resubmitted primary authentication information, comparing, by the server, the resubmitted primary authentication information to the registered primary authentication information stored in the user authentication database, and, if the resubmitted primary authentication information matches the registered primary authentication information, transmitting, by the server, to the user device, an additional primary verification message.

In an exemplary embodiment, the method may further comprise, if the probability that the current user is the registered user is below the authentication uncertainty threshold, transmitting, by the server, to the user device, a failure message indicating that the user is not authenticated based on the secondary authentication image and the hardware identifier, wherein the failure message includes a command not to transmit an additional secondary authentication request.

In an exemplary embodiment, the secondary authentication image may include the tokenized version of the user information requested by the input field. The additional primary verification message may include the tokenized version of the user information requested by the input field. The additional primary verification message may include a call to a local memory of the user device storing the tokenized version of the user information.

In an exemplary embodiment, the secondary authentication image may comprise a plurality of images of the user from more than one angle. The secondary authentication image may comprise a video.

In an exemplary embodiment, a system for persistent authentication of a registered user comprises a processor, a memory, and a transmitter, wherein the processor is configured to receive a request, via the transmitter, for a tokenized version of user information associated with a user account, wherein the request contains information to identify a user, determine whether a primary verification message has previously been received, if the primary verification message has been received, initiate a camera to capture a secondary authentication image of a current user, transmit a secondary authentication request including the secondary authentication image, receive a secondary verification message indicating that the user is authenticated based on the secondary authentication image or a failure message indicating that the user is not authenticated based on the secondary authentication image, and, if the secondary verification message is received, populate the input field with the tokenized version of the user information requested by the input field.

### BRIEF DESCRIPTION OF THE DRAWINGS

FIG. 1 is an illustration of a system for persistent authentication of a user for issuing virtual tokens, in accordance with an example embodiment of the present invention.

FIG. 2 is an illustration of a system for persistent authentication of a user for issuing virtual tokens, in accordance with an example embodiment of the present invention.

FIG. 3 is a flowchart illustrating a method for persistent authentication of a user for issuing virtual tokens, in accordance with an example embodiment of the present invention.

FIG. 4 is an illustration of a system for persistent authentication of a user for issuing virtual tokens, in accordance with an example embodiment of the present invention.

FIG. 5 is an illustration of a system for persistent authentication of a user for issuing virtual tokens, in accordance with an example embodiment of the present invention.

FIG. 6 is a flowchart illustrating a method for persistent authentication of a user for issuing virtual tokens, in accordance with an example embodiment of the present invention.

FIG. 7 is a flowchart illustrating a method for persistent authentication of a user for issuing virtual tokens, in accordance with an example embodiment of the present invention.

### DETAILED DESCRIPTION

The following description of embodiments provides non-limiting representative examples referencing numerals to particularly describe features and teachings of different aspects of the invention. The embodiments described should be recognized as capable of implementation separately, or in combination, with other embodiments from the description of the embodiments. A person of ordinary skill in the art reviewing the description of embodiments should be able to learn and understand the different described aspects of the invention. The description of embodiments should facilitate understanding of the invention to such an extent that other implementations, not specifically covered but within the knowledge of a person of skill in the art having read the description of embodiments, would be understood to be consistent with an application of the invention.

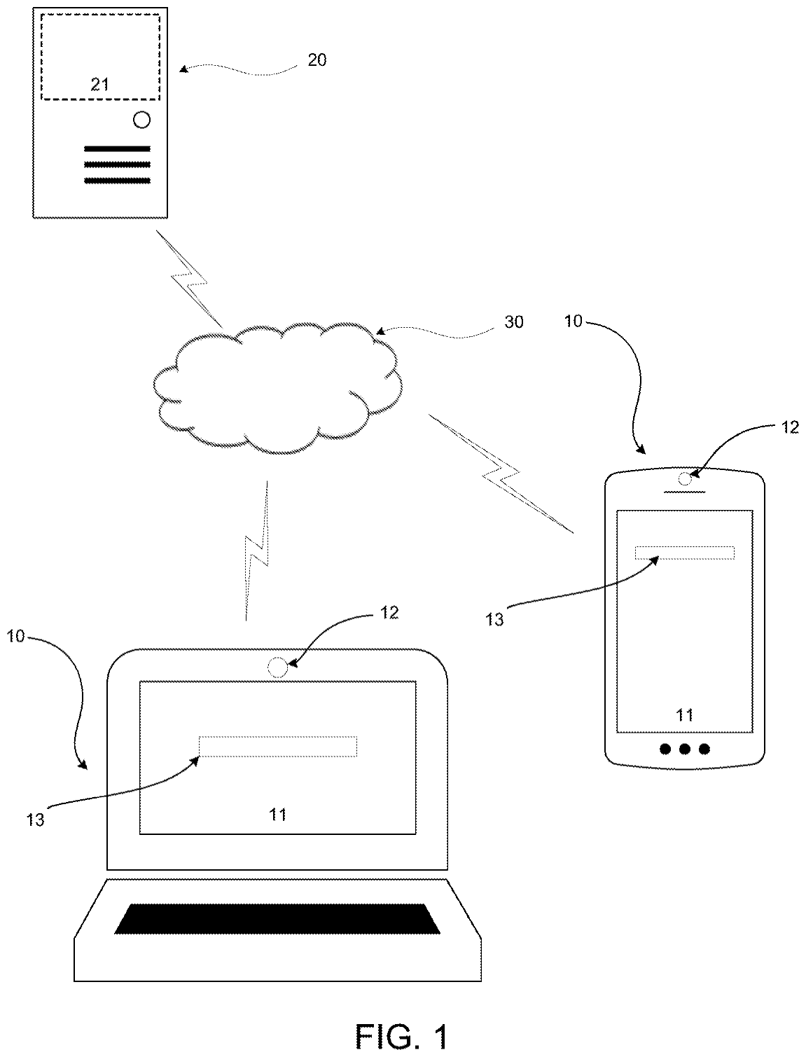

An exemplary embodiment of the overall system of the present invention is illustrated in FIG. 1. User device 10 may be any appropriate device, such as a personal computer, laptop, smartphone, personal digital assistant, tablet computer, wearable device such as a smartwatch, smart glasses, or head mounted display, or the like. User device 10 includes a computing device capable of communicating with server 20, which includes local communication with a local device for communicating with server 20. User device 10 includes user input/output and computing components generally known to mobile computing devices, including display 11, camera 12, keyboard, touch screen, or microphone, suitable computing components for processing and executing mobile applications and associated software, and known suitable components for communicating with a remote server on a network 30, such as via the Internet. The computing components of user device 10, including memory and processors, may be used to store and execute applications, as well as programs for receiving input from users and from remote computing devices, such as servers. Further, memory may be used to store information collected by the applications from user input.

User device 10 may further include an internet browser for displaying websites on display 11. Websites may include, for example, one or more input fields 13, for a user to submit information. The internet browser may also include a browser extension, or similar program, for monitoring the user of the internet browser to determine whether the internet browser is displaying a website including one or more input fields 13, and for determining whether tokenized information should be generated for use with the displayed website.

At least some portion of the systems and methods described as being carried out by the user device may be divided among multiple user devices. For example, if one device communicates with a remote server (such as a laptop or smartphone), and a separate device includes a camera, the two user devices may coordinate to carry out the invention. User device 10 may further be communicating with the network 30 and server 20 via known intermediary devices (such as routers) and still be within the scope of the systems and methods described herein.

Server 20 may be located remote from the user device, and includes a user authentication database 21, processing components, and components for communicating with user devices on a network 30, such as via the Internet. These components of the server 20 may be used to process and evaluate received information, to store information relating to users, and to communicate with user devices running applications regarding the stored user information.

The computer processing functions described herein can be carried out on the server 20 or on user device 10. Running programs locally on user device 10 may permit the program to run more quickly, if user device 10 has sufficient processing capabilities, because of the reduced need to communicate with server 20. Alternatively, running programs on server 20 would avoid storage and processing limitations that may be experienced on user device 10.

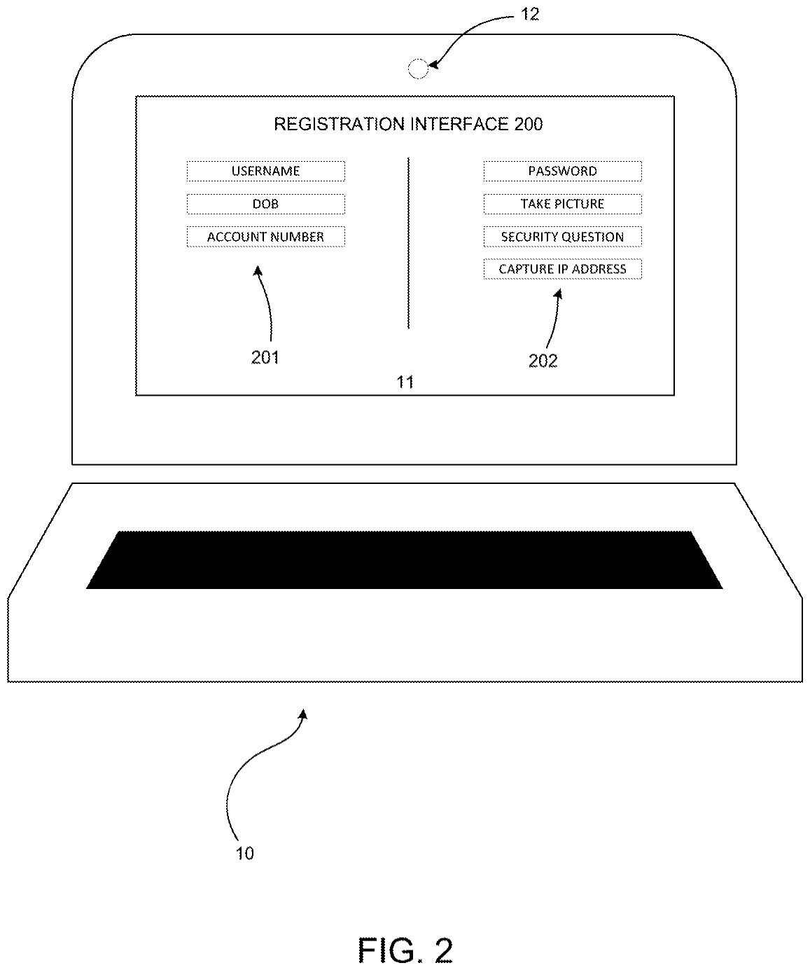

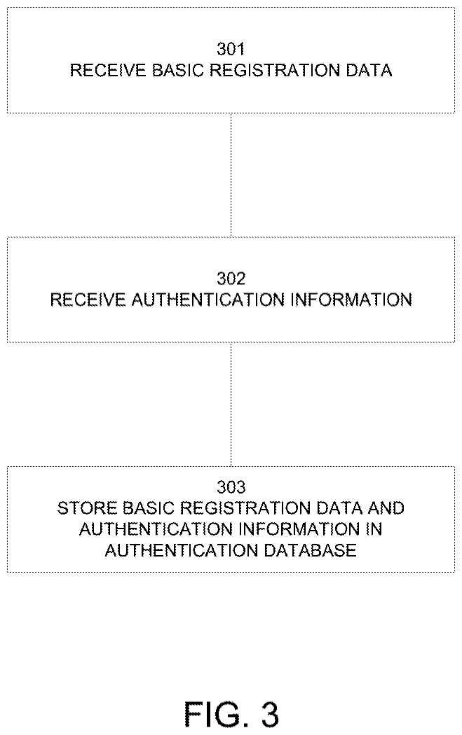

In an exemplary embodiment, the user will participate in the registration process illustrated in FIGS. 2 and 3. User device 10 is illustrated, displaying registration interface 200 on display 11, while FIG. 3 illustrates the registration process. In FIG. 2, user input fields are made available for receiving various information from the user as part of the registration process. In Step 301 of the registration process, basic registration data 201 is obtained from the user, and submitted to the server 20, to be stored in the user authentication database 21. This basic registration data may, for example, include the user's name, username, account number, date of birth, email address, cell phone number, or the like, sufficient to identify the user and/or the user's account.

In Step 302, authentication information 202 is obtained from the user, which may form the basis for the authentication processes described herein. This information may include, for example, a password, answers to personal questions more likely to be known only to the user (i.e., a security question), background information such as the user's prior mailing addresses or places of employment, fingerprint information, one or more images of the user's face, or images of a user's gesture. This information may also be tied to the user's devices or internet connection, such as internet protocol addresses or hardware identifiers for the user's devices. The information may be processed in a manner that makes the information easier to use; for example, the images of a user's face may be processed by known facial mapping methods, to represent the image as a facial map of critical facial topography for matching with images presented later in the authentication process. The registration interface 200 may include a link or button for commanding the device 10 to initiate the camera 12 to capture an image of the user, for submission as part of Step 302 of the registration process.

In Step 303, the information obtained from the user is stored in the user authentication database 21 on server 20. In the database, each entry is associated with a user. The user can be associated with an entry by the user's name or other personal information, or a user identifier or account number may be generated to associate a particular user with their entry in the database.

To complete registration, the user may also be required to agree to having the user's picture captured during subsequent authentication procedures.

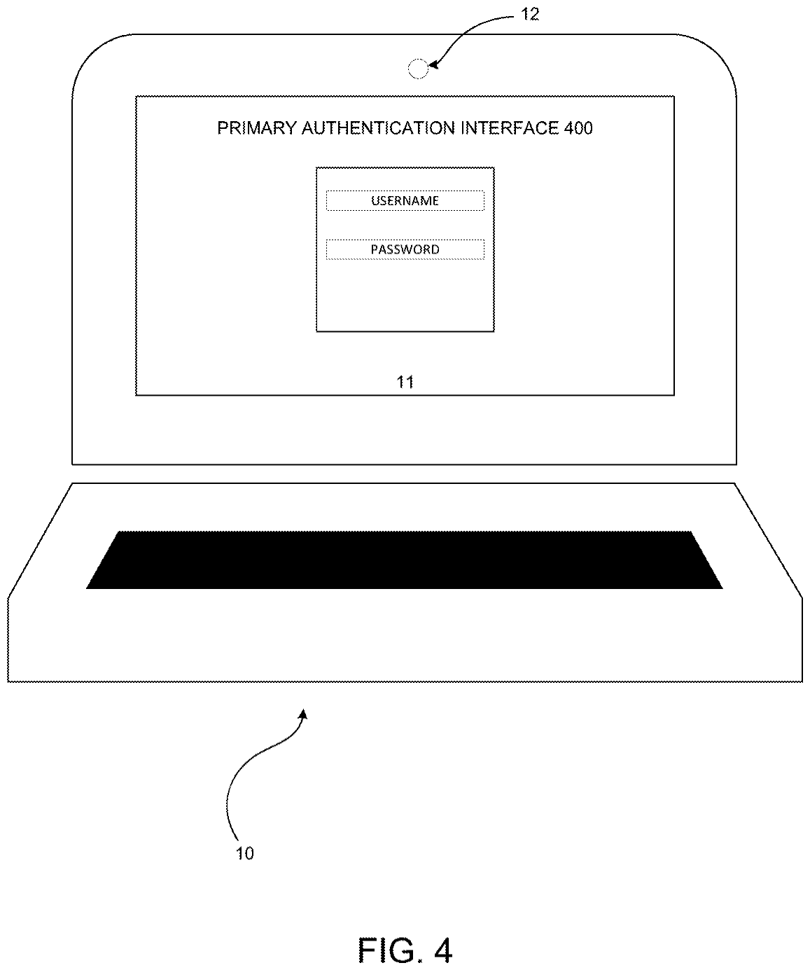

In an exemplary embodiment, as illustrated in FIG. 4, a primary authentication interface 400 is presented to the user upon initiation of a primary network browsing session for sending and receiving information over a network. To complete the primary authentication, the primary authentication interface 400 may receive at least one of the basic registration data 201, such as a username, to identify the user or the account associated with the user, as well as at least one of the authentication information 202, such as the user's password that was submitted during the registration process. The primary authentication process may use any such authentication information 202 to authenticate the user or the use of the user's device 10. The primary authentication process may further include multi-factor authentication such as requesting answers to a security question, submission of background information, fingerprint information, or the submission of a code sent to an email address or telephone number associated with the user's account.

In an exemplary embodiment, the submitted primary authentication information is then transmitted from the user device 10 to the server 20 as part of a primary authentication request. The primary authentication request may, for example, include the primary authentication information, such as the username and password, or the like, as well as a hardware identifier associated with the user device 10. Server 20 may receive the primary authentication request and compare the information contained therein with the information stored in user authentication database 21. If the primary authentication information and the hardware identifier match the information associated with the user's account stored in the user authentication database, the server 20 may transmit a primary verification message back to the user device 10, indicating that the user has been authenticated by the server 20. The server 20, the user device 10, or both, may store the verification message to allow the user device 10 to later determine that the primary verification has already been passed.

In an exemplary embodiment, the primary authentication process may further provide for the obtaining of information associated with the user device 10, or images of the user, contemporarily with the primary authentication process. For example, the Internet protocol address associated with the user device 10 at the time of the primary authentication process may be captured and stored as a primary authentication internet protocol address. Similarly, the camera 12 may be initiated to capture an image of the user at the time of the primary authentication process.

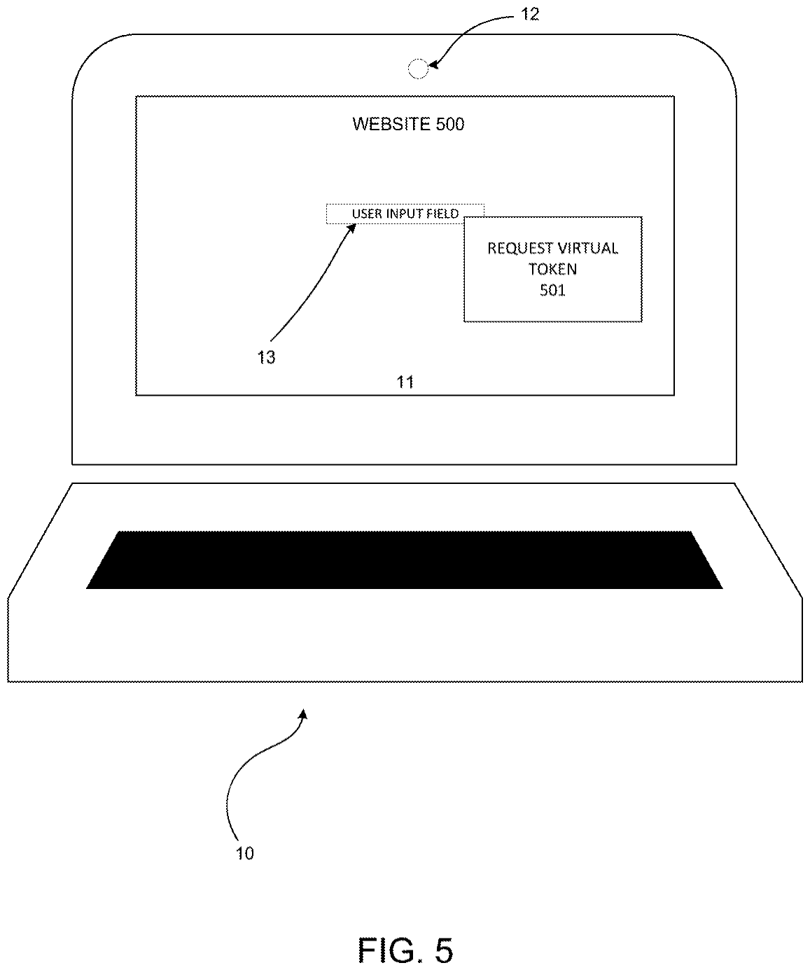

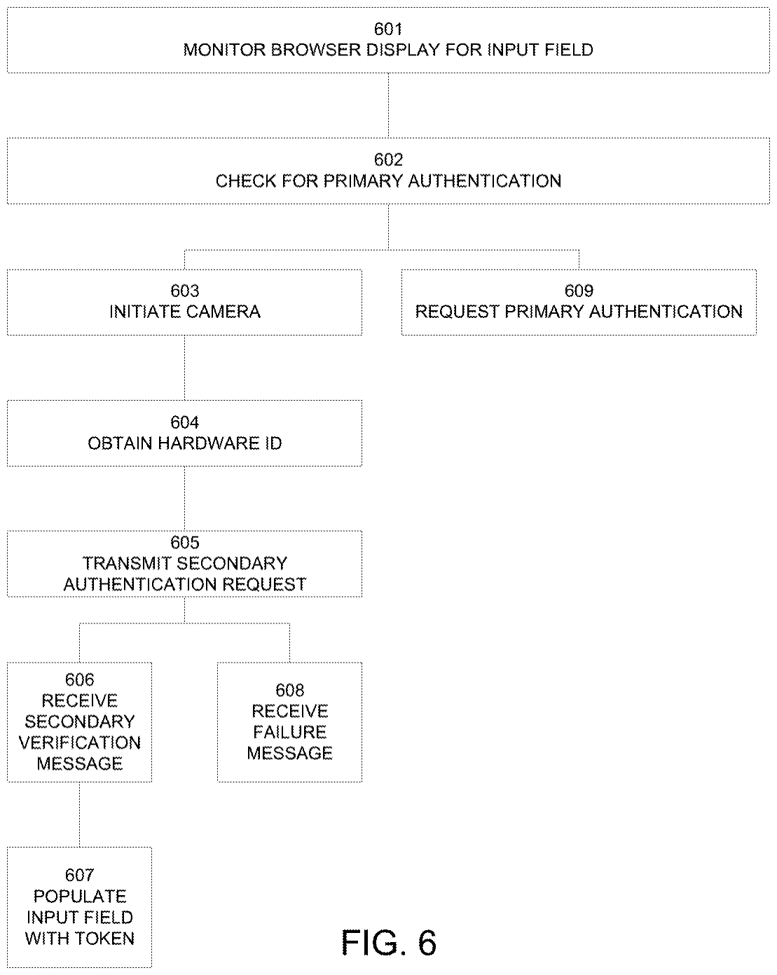

Following the primary authentication of the user, the user may continue to use the user device 10 to browse the Internet. As illustrated in FIGS. 5 and 6, in the same primary network browsing session, or in later browsing sessions, as information is being requested, sent, and received over the network, the user may reach a website 500 that requests certain user input comprising information that the user deems to be sensitive or otherwise appropriate for higher levels of security. For example, the user may reach a website that requests the user's social security number, medical records, vehicle information, tax information, financial information, payment account information, or the like. In Step 601, the user's browser display may be monitored for a user input field 13. A software program, such as the browser extension, may be monitoring the user's browsing session to determine whether the user has reached such a website with such a user input field 13. The browser extension may be configured to monitor for certain input fields. For example, the browser extension may be configured to look only for input fields for certain types of numbers, i.e., social security numbers or credit card numbers, to initiate a procedure for generating a virtual token to be submitted in place of the user's real information. The monitoring browser extension may operate by known text searching methods, image recognition methods, or other methods of reading the underlying code, headers, tags, metadata or other information associated with a webpage to identify relevant input fields. In an exemplary embodiment, tags associated with the web site page may be monitored and used to highlight the relevance of certain types of information, or alternatively to indicate that the entire page does not require virtual tokens and may be ignored. If changes are made to the website over time, those changes may be monitored to permit the website page, and its associated tags, to be reviewed again to determine if virtual tokens are required. Alternately, a website page may be reviewed or monitored at designated time intervals. In addition, a website may be transmitting messages indicating that certain personal information will be requested, so that virtual tokens will be required.

Once it is determined that the browser is displaying a user input field 13, the process for secondary authentication, to permit the generation of a virtual token representing the requested user information, may be initiated. In an exemplary embodiment, a request virtual token icon 501 may appear in the display 11, which may be generated by a processor in connection with a graphics module of user device 10. In alternative embodiments, icon 501 may appear automatically upon the discovery of the user input field 13, or may be initiated by the user, for example, by clicking, selecting, or touching the user input field 13. If the user would like to obtain a virtual token to represent the personal information requested by the user input field 13, the user may select the request virtual token icon 501. Alternatively, the request for a virtual token may be transmitted automatically upon detection of user input field 13, without direction from the user. In a further alternative, the request for a virtual token may be transmitted after the secondary authentication process has been carried out and the user has been successfully authenticated. In Step 602, the user device 10 may determine whether the primary verification message was previously received from the server 20 or was previously stored by the server 20, either by checking the memory internal to the user device 10, or by requesting such confirmation from the server 20. If the primary verification message was previously received from or stored by the server 20, the process proceeds to Step 603, for secondary authentication. If no primary verification message was previously received from or stored by the server 20, the process proceeds to Step 609, and the primary authentication process begins, requesting the basic registration data 201 and the primary authentication information 202.

The secondary authentication process, at Step 603, may include initiating the camera 12 associated with the user device 10. The initiation of camera 12 may be preceded by a request to the user for permission to initiate the image capture, in the form of an alert or dialog box. Alternatively, the initiation of camera 12 and the image capture process may be done without any indication to the user, either with no notice to the user or with the prior consent of the user submitted during the registration process. Capturing the user's image without indication may be advantageous to present a more streamlined secondary authentication procedure for the user, or if the user is attempting a fraudulent use and may be caught in the act with a picture that may be used to identify the fraudulent user.

The camera 12 then captures a secondary authentication image of the current user operating the user device 10, to be compared with the previously-stored images of the authentic user. The secondary authentication image may be one or more still pictures, or may be video, which may help to capture the user image in greater detail or from angles or views to better assist the system in properly recognizing the user. User device 10 may require the user to input a command for the camera to capture the image (i.e., may require a user to take the picture), or user device 10 may be configured to determine when the user is within view of the camera and automatically capture the image without input of the user. In an exemplary embodiment, it is not necessary to display the image to the user, or to request the user to provide additional input, but instead to automatically capture the facial image necessary to perform the secondary authentication process, to relieve the burden on the user to actively participate in the secondary authentication process. By limiting the user's active involvement in the secondary authentication process, the secondary authentication process provides the persistent, passive, authentication procedure that enables a user to seamlessly participate in online activities without exposing personal information, and without significant authentication burdens. Similarly, at Step 604, the hardware identifier associated with the user device 10 may be obtained, for example, automatically, without user input. At Step 605, a secondary authentication request may be transmitted to the server, including the secondary authentication image and the hardware identifier.

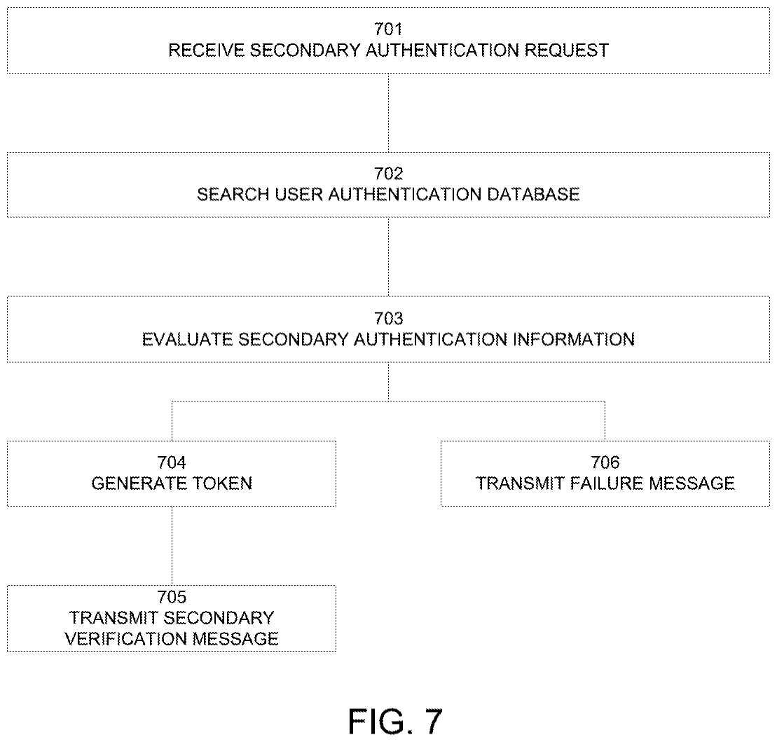

At this stage of the secondary authentication process, the description shifts to the process illustrated in FIG. 7, taking place at the server 20. At Step 701, the server 20 receives the secondary authentication request. At Step 702, the processing components of server 20 may search the user authentication database 21 for the information associated with the user, and may then, at Step 703, evaluate the secondary authentication request by comparing the secondary authentication image and the hardware identifier received from user device 10 to the stored information in user authentication database 21. This comparison may include a comparison of submitted text to the text stored in user identification database 21, and a comparison of the secondary authentication image to images stored in user identification database 21. If, for example, the image includes the user's face, the facial image may be mapped and compared to mapped facial features according to known facial mapping and facial recognition techniques. Facial mapping may include, for example, determining the distances between a variety of facial features.

As noted above, the secondary authentication image may comprise multiple images, or may include video. A series of pictures from different angles, or a video, may help to map various aspects of the user's face for a more accurate comparison. A series of pictures may also allow for a more flexible comparison of each image individually, as the aggregate or combined level of satisfaction in the comparison may be stronger than the images individually. In addition, a series of pictures or a video may help to guard against the possibility that the image captured by the camera 12 was not itself a picture of the user (i.e., a fraudulent user aiming the camera 12 at an image of the authentic user), because it can be determined whether the user moved, even a slight amount, between pictures or over the course of a video, as would a live user.

This comparison may be flexible, so that the secondary authentication image need not be identical to the stored image to satisfy the secondary authentication procedure. A flexible comparison may also permit various levels of satisfaction of the secondary authentication process, and allow an appropriately adjusted response, such as a request for an additional authentication information, in lieu of an outright denial of authentication. For example, if the facial mapping results in a probable—but not certain—match, that may be sufficient in certain circumstances to permit the issuance of a virtual token. In other circumstances, additional authentication information may be required, for example, the user may be asked to deliberately capture an additional image of the user's face, or to re-submit the primary authentication information.

As noted above, in an exemplary embodiment, the primary authentication process may further provide for the obtaining of information associated with the user device 10, or images of the user, contemporarily with the primary authentication process. For example, the Internet protocol address associated with the user device 10 at the time of the primary authentication process may be captured and stored as a primary authentication internet protocol address. The Internet protocol address may also be a range if IP addresses, such as a classless inter-domain routing (CIDR) block. Similarly, the camera 12 may be initiated to capture an image of the user at the time of the primary authentication process. In an exemplary embodiment, the evaluation carried out by the server 20 may further include a comparison of Internet protocol address with the Internet protocol address captured at the time of the primary authentication process, or a comparison of the secondary authentication image to the image of the user captured at the time of the primary authentication.

Following the evaluation of the secondary authentication request, at Step 704, if the evaluation results in a sufficient match of the secondary authentication image and the hardware identifier, the server 20 may generate a virtual token, representing the information requested by the user input field 13. A token-generating process is called on the server, generating a number that meets the standards necessary for the user input field 13, and mapping that number to the account associated with the user. In an exemplary embodiment, the number may be a credit card number, and the merchant or payment processor who receives the tokenized credit card number may forward the tokenized number with the payment request to, e.g., a financial institution that may determine the account associated with the tokenized credit card number. In another exemplary embodiment, the number may be a social security number, and the entity who receives the social tokenized security number may forward the tokenized number with the associated request, e.g., for a background check, to the relevant agencies who may determine the user associated with the tokenized social security number.

At Step 705, the server 20 may transmit a secondary verification message back to the user device 10 including the generated token. Alternatively, at Step 706, if the evaluation does not result in a sufficient match of the secondary authentication image and the hardware identifier, the server 20 may transmit a failure message back to the user device 10.

In an alternative embodiment, the request for a virtual token may be transmitted after the secondary authentication process has been carried out. In such an embodiment, the virtual token may have previously been generated and stored, either remotely or locally on the user device 10. If the previously-generated virtual token is stored remotely, the secondary verification message may include the virtual token. If the previously-generated virtual token is stored locally, the secondary verification message may include a call to the local memory to access the virtual token, such that upon receipt of the secondary verification message, the virtual token may be called from the memory and populated to the input field.

Returning to FIG. 6, at Step 606, the user device 10 may receive the secondary verification message, indicating that the current user has passed the secondary authentication process. At Step 607, the generated virtual token may then be populated to the user input filed 13, as a stand-in for the true user information. In an exemplary embodiment, upon receipt of the token, the recipient of the token may then contact the appropriate entity to obtain the necessary information, e.g., to identify a person, to identify a vehicle, to process a payment, to verify medical records, etc.

Alternatively, at Step 608, the user device 10 may receive the failure message, indicating that the current user has not passed the secondary authentication process. In response to a failure message, no token will be generated or populated into input field 13. However, the failure message received by user device 10 from server 20 may indicate that further user authentication information may be used to satisfy the authentication requirements. For example, the system may be configured such that any failure message results in another opportunity for the user to submit a secondary authentication request. As another example, the flexible comparison of the secondary authentication request may indicate that, while the secondary authentication requirements were not satisfied, there is some indication that the user is authentic, and should therefore be provided with another opportunity to demonstrate authenticity by providing additional authentication information. As another example, the comparison of the secondary authentication request may indicate that the secondary authentication requirements were not satisfied to such an extent that the current user has sufficiently been determined to be a fraudulent or otherwise unauthorized user, and further login or authentication procedures are prohibited or otherwise deactivated. As another example, further authentication procedures may be prohibited or otherwise deactivated for a certain period of time. As a further example, the browser extension may be disabled, or may be disabled for a certain period of time.

In an exemplary embodiment, the system may be configured to limit additional authentication attempts if the sought virtual token is related to a particular activity, such as submitting medical information or social security numbers. In an exemplary embodiment, the system may be configured to permit additional authentication attempts if the sought virtual token is related to a particular activity, such as purchases from a merchant that is designated to be reliable, or purchases for less than a certain monetary amount.

The present disclosure is not to be limited in terms of the particular embodiments described in this application, which are intended as illustrations of various aspects. Many modifications and variations can be made without departing from its spirit and scope, as may be apparent. Functionally equivalent methods and apparatuses within the scope of the disclosure, in addition to those enumerated herein, may be apparent from the foregoing representative descriptions. Such modifications and variations are intended to fall within the scope of the appended representative claims. The present disclosure is to be limited only by the terms of the appended representative claims, along with the full scope of equivalents to which such representative claims are entitled. It is also to be understood that the terminology used herein is for the purpose of describing particular embodiments only, and is not intended to be limiting.

1. A method for persistent authentication of a registered user of a user device, the method comprising:
following the initiation, on the user device, of a primary network browsing session for sending and receiving information over a network, receiving, by the user device, primary authentication information associated with the registered user of the user device;
transmitting, by the user device, to a server, a primary authentication request including the primary authentication information and a hardware identifier associated with the user device;
receiving, by the user device, from the server, a primary verification message;
during the primary network browsing session or during a subsequent network browsing session, detecting, on the user device, an input field and identifying the input field as requesting sensitive user information;
determining, by the user device, that the primary verification message has been received;
if the primary verification message has been received, initiating, by the user device, a camera associated with the user device to capture a secondary authentication image of the current user operating the device;
transmitting, by the user device, to a server, a secondary authentication request including the secondary authentication image and the hardware identifier;
processing, by the server, the secondary authentication image to generate a secondary authentication image facial mapping;
comparing, by the server, the secondary authentication image facial mapping to stored user information;
determining, by the server, a probability that the secondary authentication image facial mapping matches the stored user information;
receiving, by the user device, from the server, a secondary verification message indicating that the user is authenticated based on the secondary authentication image and the hardware identifier if the probability exceeds a threshold or a failure message indicating that the user is not authenticated based on the secondary authentication image and the hardware identifier if the probability is less than a threshold;
if the secondary verification message is received, populating the input field with a tokenized version of the sensitive user information requested by the input field; and
if the failure message is received, disabling the detection of the input field and the identification of the input field as requesting sensitive user information.

2. The method of claim 1,
wherein the step of transmitting the primary authentication request further includes determining a primary authentication internet protocol address of the user device indicating the internet protocol address of the user device at the time of the primary authentication request, and including the determined primary authentication internet protocol address of the user device in the primary authentication request;
wherein the step of transmitting the secondary authentication request further includes determining a secondary authentication internet protocol address of the user device indicating the internet protocol address of the user device at the time of the secondary authentication request, and including the determined secondary authentication internet protocol address of the user device in the secondary authentication request; and
wherein the secondary verification message or failure message is further based on a comparison of the primary authentication internet protocol address of the user device and the secondary authentication internet protocol address of the user device.

3. The method of claim 1, further comprising:
at the initiation of a subsequent network browsing session, initiating, by the user device, the camera associated with the user device to capture a browsing session image of the user; and
transmitting, by the user device, to the server, the browsing session image of the user;
wherein the secondary verification message or failure message is further based on a comparison of the browsing session image and the secondary authentication image.

4. The method of claim 1, wherein the initiation of the camera associated with the user device includes displaying, on a display of the user device, a prompt for the user to enter a command for the camera to capture the secondary authentication image.

5. The method of claim 1, further comprising,
if the failure message is received, declining to populate the input field.

6. The method of claim 1, further comprising,
if the failure message is received, prompting the user to submit the primary authentication information;
transmitting, by the user device, to the server, an additional primary authentication request including the resubmitted primary authentication information;
receiving, by the user device, from the server, an additional primary verification message including a tokenized version of the sensitive user information requested by the input field; and
if the additional primary verification message is received, populating the input field with the tokenized sensitive user information.

7. The method of claim 1, further comprising:
if the failure message is received, disabling the method step of transmitting the secondary authentication request.

8. The method of claim 7, wherein the disabling step is disabled for a predetermined period of time.

9. The method of claim 1, wherein the secondary verification message includes the tokenized version of the sensitive user information.

10. The method of claim 1, wherein the secondary verification message includes a call to a local memory of the user device storing the tokenized version of the sensitive user information.

11. The method of claim 1, further comprising:
detecting the party requesting the sensitive user information via the input field;
comparing the party to a list of trusted parties; and
if the party is included in the list of trusted parties, populating the input field with locally stored sensitive user information.

12. The method of claim 1, wherein the primary authentication information associated with the registered user of the user device includes at least one of: a user's name, a user identifier, a password, or an answer to a security question.

13. A method for persistent authentication of a registered user of a user device, the method comprising:
storing, in a user authentication database on a server, registered primary authentication information associated with the registered user, a registered hardware identifier associated with the user device, and at least one registered image of the registered user;
receiving, by the server, from the user device, a primary authentication request including primary authentication information and a hardware identifier;
comparing, by the server, the received primary authentication information and hardware identifier to registered primary authentication information and the registered hardware identifier stored in the user authentication database;
if the received primary authentication information and hardware identifier match the registered primary authentication information and the registered hardware identifier stored in the user authentication database, transmitting, by the server, to the user device, a primary verification message, and, in the user authentication database, storing a primary verification flag with the hardware identifier;
receiving a browsing session initiation message from the user device, including a request for a tokenized version of user information;
receiving, by the server, from the user device, a secondary authentication request including a secondary authentication image of the current user operating the device and the hardware identifier;
determining whether the user authentication database entry for the hardware identifier includes the primary verification flag;
if the user authentication database entry for the hardware identifier includes the primary verification flag;
generating a secondary authentication image facial mapping of the secondary authentication image;
comparing the secondary authentication image facial mapping to the at least one registered image of the registered user, an
determining a probability that the secondary authentication image facial mapping matches the at least one registered image of the registered user;
if the probability is above an authentication threshold, tokenizing the requested user information, and transmitting, by the server, to the user device, a secondary verification message indicating that the user is authenticated based on the secondary authentication image and the hardware identifier;
if the probability is below the authentication threshold, and above an authentication uncertainty threshold, transmitting, by the server, to the user device, a failure message indicating that the user is not authenticated based on the secondary authentication image and the hardware identifier; and
if the failure message is received, disabling the detection of the input field and the identification of the input as requesting sensitive user information.

14. The method of claim 13, wherein the failure message includes a request for an additional primary authentication request, further comprising:
receiving, by the server, from the user device, the additional primary authentication request including resubmitted primary authentication information;
comparing, by the server, the resubmitted primary authentication information to the registered primary authentication information stored in the user authentication database; and
if the resubmitted primary authentication information matches the registered primary authentication information, transmitting, by the server, to the user device, an additional primary verification message.

15. The method of claim 13, further comprising:
if the probability is below the authentication uncertainty threshold, transmitting, by the server, to the user device, a failure message indicating that the user is not authenticated based on the secondary authentication image and the hardware identifier, wherein the failure message includes a command not to transmit an additional secondary authentication request.

16. The method of claim 13, wherein the secondary authentication image includes the tokenized version of the user information requested by the input field.

17. The method of claim 14, wherein the additional primary verification message includes the tokenized version of the user information requested by the input field.

18. The method of claim 14, wherein the additional primary verification message includes a call to a local memory of the user device storing the tokenized version of the user information.

19. The method of claim 13, wherein the secondary authentication image comprises at least one selected from the group of a plurality of images of the user from more than one angle, and a video.

20. A system for persistent authentication of a registered user, comprising:
a processor, a memory, and a transmitter, wherein the processor is configured to:
receive a primary authentication request including the primary authentication information and a hardware identifier associated with the user device;
comparing the received primary authentication information and hardware identifier to registered primary authentication information and the registered hardware identifier stored in a user authentication database;
if the received primary authentication information and hardware identifier match the registered primary authentication information and the registered hardware identifier stored in the user authentication database, transmitting a primary verification message;
receive a secondary authentication request including a secondary authentication image;
generate a secondary authentication image facial mapping of the secondary authentication image;
compare the secondary authentication image facial mapping to a stored image;
determine a probability that the secondary authentication image facial mapping matches the stored image;
if the probability exceeds a threshold, transmit a secondary verification message indicating that the user is authenticated based on the secondary authentication image, or
if the probability is less than a threshold, transmit a failure message indicating that the user is not authenticated based on the secondary authentication image and disable a detection of an input field and an identification of the input field as requesting sensitive user information.
